(19) United States
(12) Patent Application Publication
(10) Pub. No.: US 2017/0044406 A1
(43) Pub. Date: Feb. 16, 2017

(54) CONSTRUCTION MATERIALS INCLUDING A NON-WOVEN LAYER OF PRESSURE-SENSITIVE ADHESIVE

(71) Applicant: FIRESTONE BUILDING PRODUCTS CO., LLC, Indianapolis, IN (US)

(72) Inventors: Michael John HUBBARD, Anderson, IN (US); Wensheng ZHOU, Carmel, IN (US); Genaro MUNOZ, Granville, OH (US); Jiansheng TANG, Westfield, IN (US)

(73) Assignee: FIRESTONE BUILDING PRODUCTS CO., LLC, Indianapolis, IN (US)

(21) Appl. No.: 15/306,522

(22) PCT Filed: Apr. 27, 2015
(86) PCT No.: PCT/US15/27722

§ 371 Date: Oct. 25, 2016

Related U.S. Application Data
(60) Provisional application No. 61/984,289, filed on Apr. 25, 2014.

(51) Int. Cl. C09J 7/04; C09J 195/00; B32B 5/02; E04C 2/284; B32B 7/12; E04C 2/02; E04B 1/62; E04D 5/14; C09J 153/02; B32B 5/26

(52) U.S. Cl. CPC C09J 7/045; C09J 153/02; C09J 195/00; B32B 5/022; B32B 5/26; B32B 7/12; E04C 2/02; E04B 1/625; E04D 5/148; E04C 2/284; C09J 2400/263; C09J 2495/00; C09J 2453/00; B32B 2255/02; B32B 2255/26; B32B 2307/748; B32B 2307/724

(57) ABSTRACT

A construction composite comprising a construction article having a planar surface and a non-woven layer of pressure-sensitive adhesive disposed on the planar surface.

This application claims the benefit of U.S. Provisional Application Ser. No. 61/984,289, filed on Apr. 25, 2014, which is incorporated herein by reference.

### FIELD OF THE INVENTION

Embodiments of the present invention are directed toward construction materials that include a non-woven layer of pressure-sensitive adhesive.

### BACKGROUND OF THE INVENTION

Many construction materials, especially those that have a generally planar configuration such as boards and membranes, are mechanically attached to building structures or substrates. While mechanical attachment of these construction materials is often advantageous from the standpoint of mechanical integrity, this mode of attachment also presents several shortcomings. For example, mechanical attachment methods can be time and labor intensive. Also, mechanical modes of attachment typically puncture the construction article, and these punctures typically must be repaired, which is often a labor and time intensive undertaking.

In some situations, the application of adhesive, particularly factory-applied adhesive, has been proposed for attaching building materials to the underlying structure or substrate. For example, so-called “peel-and-stick” membranes have been proposed, where pressure-sensitive adhesive material is applied to a planar surface of the building material. This adhesive layer is then covered with a release film, shipped to the construction site, and installed after removal of the release film.

While these building materials have proven useful, several draw backs remain. For example, the application of adhesive is costly, especially in view of the surface area being covered. Also, the application of adhesive can frustrate certain attributes of the construction material. For example, where the building material is desirably permeable (e.g., vapor permeable), the application of adhesive film to a planar surface of the building material may destroy the permeability of the building material.

A particular problem exists with air barriers. As the skilled person understands, air barriers (e.g., house wraps) are wind and water resistant construction fabrics that are vapor permeable, which permeability is important to avoid problems associated with dampness or condensation. While the application of pressure-sensitive adhesive would facilitate installation, improve certain product performance attributes, and generally eliminate the need to repair penetrations caused by mechanical attachment, the application of a layer of pressure-sensitive adhesive would destroy the vapor permeability of the construction fabrics.

The construction industry has nonetheless long desired a “peel-and-stick” type of air barrier. For example, U.S. Pat. No. 6,901,712 teaches an air barrier membrane that is permeable to water vapor and can be adhered to a substrate by virtue of an adhesive deposited on one side of the sheet. The adhesive is applied to the vapor-permeable membrane as a non-continuous film in order to leave parts, or spots, or zones of the sheet uncoated with adhesive.

Desiring similar goals, U.S. Publ. No. 2011/0185666 teaches a self-adhesive permeable membrane sheet including a continuous layer of permeable pressure-sensitive adhesive attached to one surface of a permeable membrane sheet. The permeable pressure-sensitive adhesive includes hydrophobic inorganic fine particles, e.g., silica, that ostensibly provide the adhesive its permeability. In alternate embodiments, the permeable adhesive includes a foamed adhesive including swellable polymer additives. Apparently relying on similar technology, U.S. Pat. No. 8,277,915 teaches a self-adhered, vapor-permeable, air barrier membrane with a pressure-sensitive adhesive that may be vapor-permeable.

Despite these teachings, the vast majority of construction materials are installed by using mechanical fastening techniques. A need therefore exists to provide improved construction material composites that include pressure-sensitive adhesives that allow for more efficient and improved modes of attachment while not deleteriously impacting the properties of the construction material.

### BRIEF DESCRIPTION OF THE DRAWINGS

FIG. 1 is a perspective, cross-sectional view of a construction article according to embodiments of the invention.

FIG. 2 is a perspective view of a construction article according to embodiments of the invention in rolled form.

### SUMMARY OF THE INVENTION

One or more embodiments of the present invention provide a construction composite comprising a construction article having a planar surface and a non-woven layer of pressure-sensitive adhesive disposed on the planar surface.

One or more embodiments of the present invention provide a self-adhering non-woven composite comprising a non-woven construction fabric and a non-woven layer of pressure-sensitive adhesive disposed on a surface of said non-woven construction material.

### DETAILED DESCRIPTION OF ILLUSTRATIVE EMBODIMENTS

Embodiments of the invention are based, at least in part, on the discovery of construction materials that include a non-woven layer of pressure-sensitive adhesive. As a result of this construction, these construction materials, which may also be referred to as composites, can be easily installed by mating the non-woven adhesive layer to a desired substrate. Among the benefits observed, the non-woven layer of pressure-sensitive adhesive provides technologically useful adhesion to the desired substrate while employing only a fraction of the material that would have otherwise been required if a continuous layer of adhesive were applied to the construction article. Additionally, it has advantageously been observed that the non-woven layer of pressure-sensitive adhesive is vapor permeable, and therefore can be used to secure vapor-permeable construction materials to a desired substrate while maintaining the vapor permeability of the overall composite. For example, particular embodiments of the invention are directed toward vapor-permeable air barrier composites that include a vapor-permeable air barrier sheet and a vapor-permeable non-woven layer of pressure-sensitive adhesive.

### Composite Construction

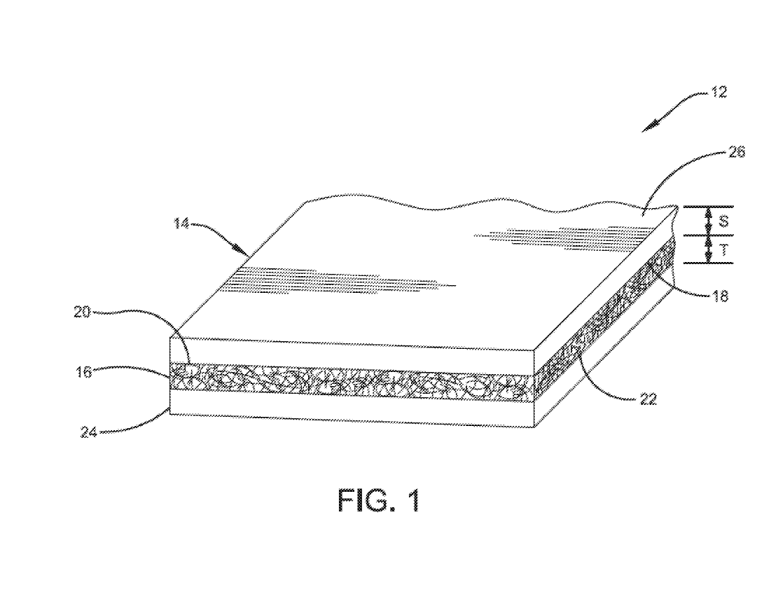

The composite of one or more embodiments of the present invention can be described with reference to FIG. 1, which shows composite 12 including a construction article 14, which may also be referred to as construction element 14, and a non-woven layer of pressure-sensitive adhesive 16. Construction article 14 may include a first planar surface 18 upon which a non-woven layer of pressure-sensitive adhesive is adhesively disposed. The thickness T of non-woven layer of pressure-sensitive adhesive 16 may be defined in a direction transverse to the planar surface 18 as shown in FIG. 1, and therefore may extend from a planar contact surface 20 where non-woven layer 16 contacts planar surface 18 to an opposed planar surface 22 of non-woven layer 16. In particular embodiments, composite 12 includes a release layer 24 removably adhered to opposed planar surface 22 of non-woven layer 16.

In one or more embodiments, and as is generally shown in FIG. 1, construction article 14 may have a thickness S defined in a direction transverse to planar surface 18 of article 14. As shown in FIG. 1, thickness S may be defined as the distance from planar surface 18 to an opposed planar surface 26.

In one or more embodiments, the non-woven layer of pressure-sensitive adhesive may be characterized by a coverage rate over the surface of construction article 14. For example, in one or more embodiments, the coverage rate of the pressure-sensitive adhesive may be from about 5 to about 40, in other embodiments from about 8 to about 30, and in other embodiments from about 10 to about 20 grams per square meter.

### Construction Article

Several construction articles can be employed in constructing the composite articles of the present invention. In one or more embodiments, the construction article (e.g., article 14) may include a sheet or membrane (and therefore reference may be made to sheet or membrane 14). In other embodiments, the construction article may include a construction board such as an insulation board or a cover board (and therefore reference may be made to board 14).

In those embodiments where construction article 14 is a sheet or membrane, the construction article may include an impermeable polymeric membrane that may optionally include a fiber reinforcement. For example, in one or more embodiments, the construction article may include a rubber membrane such as an EPDM membrane, in other embodiments a thermoplastic membrane such as a TPO membrane, or in other embodiments an asphaltic membrane such as a modified bitumen membrane.

In other embodiments, the sheet or membrane may include a fabric sheet. In one or more embodiments, the sheet or membrane is a water-resistant sheet including those sheets or membranes that are water and vapor impermeable. In other embodiments, the fabric may include a vapor-permeable fabric. In one or more embodiments, the vapor-permeable fabrics are water-resistant or water-impermeable fabrics.

In one or more embodiments, the vapor permeable fabric is Tyvec™ (DuPont), which is believed to be a spun bonded polyolefin sheet (e.g., polyethylene and polypropylene spun bonded sheet) manufactured generally in accordance with U.S. Pat. Nos. 3,532,589, and 5,972,147, which are incorporated herein by reference.

In one or more embodiments, the thickness of sheet or membrane 14, which is represented by S in FIG. 1, may be from about 5 to about 100 mils, in other embodiments from about 10 to about 80 mils, and in other embodiments from about 12 to about 40 mils.

In those embodiments where construction article 14 is a construction board, the construction board may include a polyisocyanurate and/or polyurethane foamed construction board. In one or more embodiments, these foamed construction boards may include closed-cell foamed construction boards. In one or more embodiments, the thickness T of these boards may be from 0.25 to 6 inches or in other embodiments from 0.5 to 4 inches.

### Non-Woven Pressure-Sensitive Adhesive Layer

In one or more embodiments, the non-woven layer of pressure-sensitive adhesive (e.g., layer 16), which may also be referred to as a non-woven web, fibrous non-woven web, sprayed filament adhesive filament layer, or fiberized adhesive layer, includes a fibrous network that is characterized by adhesive properties under ambient conditions. The fibers may be in the form of continuous fibers, discontinuous fibers, or both.

In one or more embodiments, the non-woven layer may be characterized by a pattern that the adhesive fibers form. In one or more embodiments, the pattern that the adhesive fibers form can be random. In one or more embodiments, the pattern that the adhesive fibers form can be substantially predetermined based on the technique used to lay down the adhesive fibers. In one or more embodiments, the pattern that the adhesive fibers form can be made using Laminated Plate Technology (ITW Dynatec), as may be further described by U.S. Pat. Nos. 5,882,573, 5,902,540, and 5,904,298, which are incorporated herein by reference. In one or more embodiments, the patterns may include spiral swirl patterns or “OMEGA” patterns as described in U.S. Pat. Nos. 6,197,406, 6,200,635, and 6,461,430, which are incorporated herein by reference.

In one or more embodiments, the adhesive fibers may be characterized by a thickness of from about 0.1 to about 1000, in other embodiments from about 0.5 to about 500, and in other embodiments from about 1.0 to about 100 μm.

Practice of the present invention is not limited by the type of pressure-sensitive adhesive composition employed to form the non-woven layer. In other words, the constituents that form the adhesive composition used to form the fibers may include conventional constituents used to form pressure-sensitive adhesive compositions. Included among useful pressure-sensitive adhesives are holt-melt adhesives, which are flowable when heated to threshold temperatures.

In one or more embodiments, the pressure-sensitive adhesive itself is characterized by a tack, as defined by the Standard Test Method for Tack of Pressure-Sensitive Adhesives by Rolling Ball (ASTM D3121-06), of less than 30 cm, in other embodiments less than 20 cm, and in other embodiments less than 10 cm.

In one or more embodiments, the pressure-sensitive adhesive itself is characterized by providing a minimum peel strength, as defined by the Standard Test Method for Peel Adhesion of Pressure-Sensitive Label Stocks at 90° Angle (ASTM D6252/D6252M-98(2011)), of at least 0.1 pli, in other embodiments at least 0.3 pli, and in other embodiments at least 0.5 pli.

In one or more embodiments, especially where the pressure-sensitive adhesive is a hot-melt adhesive, the pressure-sensitive adhesive composition may be characterized as a solid at temperatures below 200° F., in other embodiments below 190° F., in other embodiments below 180° F., and in other embodiments below 170° F. In these or other embodiments, the pressure-sensitive adhesive composition is characterized as a fluid above 200° F., in other embodiments above 250° F., in other embodiments above 300° F., and in other embodiments above 350° F.

Exemplary pressure-sensitive adhesive compositions that may be employed in preparing the non-woven layer include those compositions based upon one or more of acrylic polymers, butyl rubber, ethylene vinyl acetate, natural rubber, nitrile rubber, silicone rubber, styrene block copolymers, ethylene-propylene-diene rubber, ataticpolyalpha olefins, and vinyl ether polymers. In combination with these base polymers, the pressure-sensitive adhesive compositions may include a variety of complementary constituents such as, but not limited to, tackifying resins, waxes, antioxidants, and plasticizers.

In particular embodiments, the pressure-sensitive adhesive compositions employed in the present invention include polystyrene block copolymers. These block copolymers include at least two types of blocks, which may be referred to as A and B blocks, where the A blocks represent blocks deriving from the polymerization of at least one vinyl aromatic monomer (e.g., styrene) and the B blocks derive from the polymerization of at least one conjugated diene monomer (e.g., butadiene). Exemplary vinyl aromatic monomer includes styrene, p-methylstyrene, α-methylstyrene, and Vinylnaphthalene. Examples of conjugated diene monomer include 1,3-butadiene, isoprene, 1,3-pentadiene, 1,3-hexadiene, 2,3-dimethyl-1,3-butadiene, 2-ethyl-1,3-butadiene, 2-methyl-1,3-pentadiene, 3-methyl-1,3-pentadiene, 4-methyl-1,3-pentadiene, and 2,4-hexadiene.

In particular embodiments, the block copolymers include at least two A blocks and at least one B block. For example, the use of A-B-A block copolymers is specifically contemplated. In one or more embodiments, the B block may be hydrogenated. In one or more embodiments, the B block is characterized by at least 75 percent hydrogenation, in other embodiments at least 85 percent hydrogenation, and in other embodiments at least 95 percent hydrogenation, where the percent hydrogenation refers to the number of original double bonds within the block reduced by hydrogenation. For example, a polymer block that is 95 percent hydrogenated includes 5 percent of the original double bonds. In one or more embodiments, the aromatic unsaturation within the A blocks is hydrogenated by less than 25 percent, in other embodiments less than 15 percent, and in other embodiments less than 5 percent.

In one or more embodiments, each A block has an number average molecular weight of at least 2 kg/mole, in other embodiments at least 5 kg/mole, and in other embodiments at least 25 kg/mole. In these or other embodiments, each A block has an number average molecular weight of less than 125 kg/mole, in other embodiments less than 75 kg/mole, and in other embodiments less than 50 kg/mole.

In one or more embodiments, each B block has a number average molecular weight of at least 10 kg/mole, in other embodiments at least 30 kg/mole, and in other embodiments at least 50 kg/mole. In these or other embodiments, each A block has an number average molecular weight of less than 250 kg/mole, in other embodiments less than 175 kg/mole, and in other embodiments less than 125 kg/mole.

Exemplary styrene block copolymers include styrene-butadiene-styrene block copolymer, hydrogenated styrene-butadiene-styrene block copolymer (which may also be referred to as styrene-ethylene/butene-styrene block copolymer), styrene-isoprene-styrene block copolymer, and hydrogenated styrene-isoprene-styrene block copolymer (which may also be referred to as styrene-ethylene/propylene-styrene block copolymer). For ease of description, these polymers may be referred to, respectively, as S-B-S block copolymer, S-E/B-S block copolymer, S-I-S block copolymer, and S-E/P-S block copolymer.

The polystyrene block copolymer-based, pressure-sensitive adhesive compositions used in this invention may also include a modifying resin. In one or more embodiments, modifying resins include end-block modifying resins and/or mid-block modifying resins. As is known in the art, end-block modifying resins include those resins that modify and/or reinforce the styrene blocks of the block copolymer. It is believed that these end-block modifying resins form pseudo cross links between polymer chains. In one or more embodiments, these end-block resins are characterized by a ring and ball softening point of at least 90° C., in other embodiments at least 100° C., in other embodiments at least 110° C., in other embodiments at least 120° C., in other embodiments at least 140° C., and in other embodiments at least 160° C. Exemplary end-block modifying resins include coumarone-indene resins, poly-α-methylstyrene resins, polystyrene resins, vinyl toluene-α-methylstyrene copolymer resins, and polyindene resins. In these or other embodiments, mid-block modifying resins are employed. As is known in the art, mid-block modifying resins include those resins that modify and/or reinforce the diene blocks of the block copolymer. It is believed that these mid-block modifying resins form pseudo cross links between polymer chains. In one or more embodiments, mid-block modifying resins include aliphatic resins such as pentene-type resins, terpene resins, and cycloaliphatic resins.

Exemplary polyphenylene ether resins, such as polyphenylene oxide, may also be used. In one or more embodiments, these resins are characterized by an intrinsic viscosity of less than 0.4 dl/g, in other embodiments less than 0.35 dl/g, and in other embodiments less than 0.2 dl/g, when measured in solution in chloroform at 25° C. Useful polyphenylene ether resins are described in U.S. Pat. Nos. 3,306,874 and 3,257,375, which are incorporated herein by reference.

In one or more embodiments, the pressure-sensitive adhesives based upon styrene block copolymers may also include an adhesive promoting resin or tackifying resin. In one or more embodiments, a hydrogenated tackifying resin is employed. These resins include, but are not limited to, petroleum resins, synthetic polyterpenes, resin esters and natural terpenes, and combinations thereof. In certain embodiments, the resin modifiers soften or become liquid at temperatures of about 40° C. to about 150° C. In certain embodiments, the resin modifiers have number average molecular weights, as measured by vapor phase osmometry, below that of the polymeric material included in the polymeric film. In certain embodiments, the number average molecular weights of the resin modifiers are less than about 5,000. In other embodiments, the number average molecular weights of the resin modifiers are less than about 1,000. In additional embodiments, the number average molecular weights of the resin modifiers are from about 500 to about 1000.

In certain embodiments, the resin modifiers have ring and ball softening point of about 20° C. to about 160° C. In additional embodiments, resin modifiers have ring and ball softening points of about 40° C. to about 160° C. In still other embodiments, resin modifiers have ring and ball softening points of about 50° C. to about 160° C.

Various types of natural and synthetic resins, alone or in admixture with each other, may be used be selected as the resin modifier. Suitable resins include, but are not limited to, natural rosins and rosin esters, hydrogenated rosins and hydrogenated rosin esters, coumarone-indene resins, petroleum resins, polyterpene resins, and terpene-phenolic resins. Specific examples of suitable petroleum resins include, but are not limited to, aliphatic hydrocarbon resins, hydrogenated aliphatic hydrocarbon resins, mixed aliphatic and aromatic hydrocarbon resins, hydrogenated mixed aliphatic and aromatic hydrocarbon resins, cycloaliphatic hydrocarbon resins, hydrogenated cycloaliphatic resins, mixed cycloaliphatic and aromatic hydrocarbon resins, hydrogenated mixed cycloaliphatic and aromatic hydrocarbon resins, aromatic hydrocarbon resins, substituted aromatic hydrocarbons, and hydrogenated aromatic hydrocarbon resins. As used herein, “hydrogenated” includes fully, substantially and at least partially hydrogenated resins. Suitable aromatic resins include aromatic modified aliphatic resins, aromatic modified cycloaliphatic resin, and hydrogenated aromatic hydrocarbon resins. Any of the above resins may be grafted with an unsaturated ester or anhydride to provide enhanced properties to the resin. For additional description of resin modifiers, reference can be made to technical literature, e.g., Hydrocarbon Resins, Kirk-Othmer, Encyclopedia of Chemical Technology, 4th Ed. v. 13, pp. 717-743 (J. Wiley & Sons, 1995).

In one or more embodiments, the tackifier resins include phenol-based resins. Included among the phenol-based resins are phenolic resins. These resins may include reactive phenol resins (also referred to as functionalized phenol resins), as well as unreactive resins. In one or more embodiments, the phenolic resin is a resole resin, which can be made by the condensation of alkyl, substituted phenols, or unsubstituted phenols with aldehydes such as formaldehyde in an alkaline medium or by condensation of bi-functional phenoldialcohols. In one or more embodiments, this condensation reaction occurs in the excess or molar equivalent of formaldehyde. In other embodiments, the phenolic resin may be formed by an acid-catalyzed reaction.

In one or more embodiments, the tackifier resin is a polybutene polymer or oligomer. In particular embodiments, polybutene oils are employed. Useful polybutene oils include high-viscosity oils that may be characterized by a viscosity at 100° C. of at least 80 cst, in other embodiments at least 100 cst, or in other embodiments at least 120 cst up to, for example, about 700 or 800 cst. In these or other embodiments, the high viscosity polybutene oils may be characterized by a molecular weight of at least 1000 g/mole, in other embodiments at least 1200 g/mole, or in other embodiments at least 1300 g/mole up to, for example, 1400 or 1500 g/mole. An exemplary high-viscosity polybutene oil is available under the tradename Indapol H300 (Ineos) or PB32 (Soltex).

In particular embodiments, the tackifying resins include hydrogenated rosins, esters of rosins, polyterpenes, terpene phenol resins, and polymerized mixed olefins. In one or more embodiments, these resins are liquids at room temperature.

In other embodiments, the pressure-sensitive adhesive used to make the fibers of the non-woven layer includes an asphalt-based composition. As the skilled person understands, asphalt-based pressure-sensitive adhesives include asphalt binder and other optional ingredients such as polymeric modifiers, fillers, and tackifier resins.

The term “asphalt binder” is used as understood by those skilled in the art and is consistent with the meaning provided by AASHTO M320. As used within this specification, the terms “asphalt” and “asphalt binder” may be used synonymously. The asphalt binder material may be derived from any asphalt source, such as natural asphalt, rock asphalt, produced from tar sands, or petroleum asphalt obtained in the process of refining petroleum. In other embodiments, asphalt binders may include a blend of various asphalts not meeting any specific grade definition. This includes air-blown asphalt, vacuum-distilled asphalt, steam-distilled asphalt, cutback asphalt or roofing asphalt. Alternatively, gilsonite, natural or synthetic, used alone or mixed with petroleum asphalt, may be selected. Synthetic asphalt mixtures suitable for use in the present invention are described, for example, in U.S. Pat. No. 4,437,896. In one or more embodiments, asphalt includes petroleum derived asphalt and asphaltic residual. These compositions may include asphaltenes, resins, cyclics, and saturates. The percentage of these constituents in the overall asphalt binder composition may vary based on the source of the asphalt.

In one or more embodiments, the polymeric modifier used in conjunction with the asphalt binder may include thermoplastic polymers, thermosetting elastomers, thermoplastic elastomers, and/or mixtures thereof. Each of these polymers have been used, either alone or in combination with each other to modify asphalt binders, and practice of the present invention is not necessarily limited by the selection of any particular polymeric modifier.

In one or more embodiments, the tackifier resins used in conjunction with the asphalt binder may include petroleum resins, synthetic polyterpenes, resin esters and natural terpenes, and combinations thereof. In certain embodiments, the resin modifiers soften or become liquid at temperatures of about 40° C. to about 150° C. In certain embodiments, the resin modifiers have number average molecular weights, as measured by vapor phase osmometry, below that of the polymeric material included in the polymeric film. In certain embodiments, the number average molecular weights of the resin modifiers are less than about 5,000. In other embodiments, the number average molecular weights of the resin modifiers are less than about 1,000. In additional embodiments, the number average molecular weights of the resin modifiers are from about 500 to about 1000.

Additionally, the asphalt binder may be used in conjunction with various other additives such as fillers, extenders, antioxidants, waxes, antiozonants, and the like. Useful fillers include, but are not limited to, inorganic fillers such as calcium carbonate (i.e. limestone) and glass, such as glass beads.

In one or more embodiments, fiberized pressure-sensitive adhesive layer 16 includes a cured pressure-sensitive adhesive. In sub-embodiments thereof, this fiberized, cured pressure-sensitive adhesive layer is formed from a curable hot-melt adhesive. In other words, an uncured adhesive composition is applied to the membrane as a hot-melt composition (i.e. the composition is heated and applied as a flowable composition in the absence or appreciable absence of solvent) in a fiberized form, and then the composition is subsequently crosslinked (i.e. cured) to form the cured pressure-sensitive composition.

In one or more embodiments, the curable adhesive composition may be an acrylic-based hot-melt adhesive. In one or more embodiments, the adhesive is a polyacrylate such as a polyacrylate elastomer. In one or more embodiments, useful polyacrylates include one or more units defined by the formula:

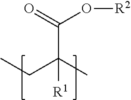

where each R¹ is individually hydrogen or a hydrocarbyl group and each R² is individually a hydrocarbyl group. In the case of a homopolymer, each R¹ and R², respectively, throughout the polymer are same in each unit. In the case of a copolymer, at least two different R¹ and/or two different R² are present in the polymer chain.

In one or more embodiments, hydrocarbyl groups include, for example, alkyl, cycloalkyl, substituted cycloalkyl, alkenyl, cycloalkenyl, substituted cycloalkenyl, aryl, substituted aryl, aralkyl, alkaryl, allyl, and alkynyl groups, with each group containing in the range of from 1 carbon atom, or the appropriate minimum number of carbon atoms to form the group, up to about 20 carbon atoms. These hydrocarbyl groups may contain heteroatoms including, but not limited to, nitrogen, oxygen, boron, silicon, sulfur, and phosphorus atoms. In particular embodiments, each R² is an alkyl group having at least 4 carbon atoms. In particular embodiments, R¹ is hydrogen and R² is selected from the group consisting of butyl, 2-ethylhexyl, and mixtures thereof.

In one or more embodiments, the polyacrylate elastomers that are useful as adhesives in the practice of this invention may be characterized by a glass transition temperature (Tg) of less than 0° C., in other embodiments less than −20° C., in other embodiments less than −30° C. In these or other embodiments, useful polyacrylates may be characterized by a Tg of from about −70 to about 0° C., in other embodiments from about −50 to about −10° C., and in other embodiments from about −40 to about −20° C.

In one or more embodiments, the polyacrylate elastomers that are useful as adhesives in the practice of this invention may be characterized by a number average molecular weight of from about 100 to about 350 kg/mole, in other embodiments from about 150 to about 270 kg/mole, and in other embodiments from about 180 to about 250 kg/mole.

In one or more embodiments, the polyacrylate elastomers that are useful as adhesives in the practice of this invention may be characterized by a Brookfield viscosity at 150° C. of from about 20,000 to about 70,000 cps, in other embodiments from about 30,000 to about 60,000 cps, and in other embodiments from about 40,000 to about 50,000 cps.

Specific examples of polyacrylate elastomers that are useful as adhesives in the practice of the present invention include poly(butylacrylate), and poly(2-ethylhexylacryalte). These polyacrylate elastomers may be formulated with photoinitiators, solvents, plasticizers, and resins such as natural and hydrocarbon resins. The skilled person can readily formulate a desirable coating composition. Useful coating compositions are disclosed, for example, in U.S. Pat. Nos. 6,720,399, 6,753,079, 6,831,114, 6,881,442, and 6,887,917, which are incorporated herein by reference.

In other embodiments, the polyacrylate elastomers may include polymerized units that serve as photoinitiators. These units may derive from copolymerizable photoinitiators including acetophenone or benzophenone derivatives. These polyacrylate elastomers and the coating compositions formed therefrom are known as disclosed in U.S. Pat. Nos. 7,304,119 and 7,358,319, which are incorporated herein by reference.

Useful adhesive compositions are commercially available in the art. For example, useful adhesives include those available under the tradename acResin (BASF), those available under the tradename AroCure (Ashland Chemical), and NovaMeltRC (NovaMelt). In one or more embodiments, these hot-melt adhesives may be cured (i.e., crosslinked) by UV light.

In one or more embodiments, the hot-melt adhesive is at least partially cured after being applied to the membrane. In one or more embodiments, the adhesive composition is cured to an extent that it is not thermally processable in the form it was prior to cure. In these or other embodiments, the cured adhesive composition is characterized by a cross-linked infinite polymer network. While at least partially cured, the adhesive composition of one or more embodiments is essentially free of curative residue such as sulfur or sulfur crosslinks and/or phenolic compounds or phenolic-residue crosslinks.

### Manufacture of Non-Woven Pressure Sensitive Adhesive

The non-woven layer of pressure-sensitive adhesive may be prepared by known extrusion techniques. In one or more embodiments, the extrusion technique for forming the fibrous non-woven web includes melt blowing techniques. As the skilled person appreciates, these processes include extruding a thermoplastic polymeric material (e.g., polymer resin) through a plurality of small diameter capillaries of a melt blowing die. The polymeric material, which is in the form of molten threads upon leaving the die, is introduced into a heated gas stream, which flows generally in the same direction as the extruded thread, and the gas stream imparts force upon the threads to attenuate (i.e., draw or extend) the threads and thereby reduce their diameter. These threads may also be referred to as microfibers or filaments. These attenuated threads are then blown away from the die by the gas stream and collected on the surface of the substrate. Stated another way, melt blowing is a process of forming fibers or filaments by drawing and attenuating a first fluid flow, like molten thermoplastic, with shear forces from an adjacent second fluid flow, like heated air, at high velocity relative to the first fluid flow. Suitable melt blowing techniques are known in the art including those techniques disclosed in U.S. Pat. Nos. 4,663,220, 4,789,699, 5,902,540, 5,904,298, and U.S. Publ. No. 2013/0084388 which are incorporated herein by reference.

In one or more embodiments, the technique for forming the fibrous non-woven web can be described as a fiberized spray technique. Fiberized spray techniques include the use of a fiberized spray applicator to apply the fibrous non-woven web. A suitable fiberized spray applicator is the DeltaFX™ fiberized spray applicator from ITW Dynatec.

In one or more embodiments, the non-woven layer of pressure-sensitive adhesive may also be prepared by fiber coating techniques that may include adding a coating to a plurality of strands. As the skilled person appreciates, these processes can include the use of a device that conveys elongated strands into or proximate to a dispensing device, where a coating, such as an adhesive, is dispensed onto the strands. These strands may also be referred to as threads, fibers, microfibers, or filaments. One or more guide implements may also be used to aid in conveying strands into or proximate to a dispensing device. Suitable coating techniques and devices are known in the art including those techniques and devices disclosed in U.S. Pat. Nos. 7,067,009; 7,771,786; and 8,033,243, which are incorporated herein by reference.

### Release Liner

In one or more embodiments, the release liner may include a paper or cellulosic structure coated with a polymeric coating. In other embodiments, the release liner may include a homogeneous polymeric structure; for example, the release liner may include a polyester or polyolefin film. Suitable materials for the release liner include polypropylene, polyester, high-density polyethylene, medium-density polyethylene, low-density polyethylene, polystyrene or high-impact polystyrene. These polymeric materials offer a number of advantageous properties, including high moisture resistance, good resistance to temperature fluctuations during processing and storage, high tear resistance. In one or more embodiments, these release liners may also be provided with anti-static surface coatings. In addition to the above polymeric release liner materials, the release liner may also be made of kraft paper.

### Manufacture of Composite

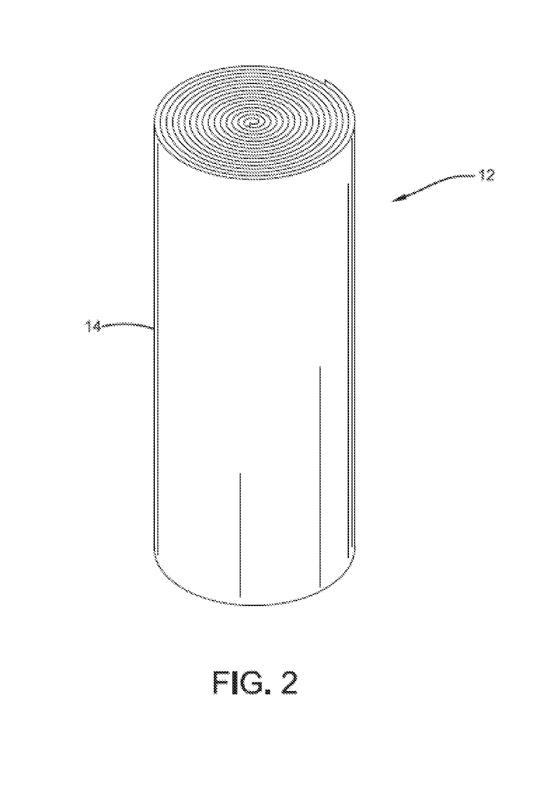

In one or more embodiments, the composites of the present invention are manufactured continuously. According to one or more embodiments, construction articles (e.g., boards, membranes, or fabric) are continuously fed along a production line and serve as a substrate upon which the fiberized adhesive is directly deposited. In other words, the pressure-sensitive adhesive material is applied directly on to a surface (e.g., a planar surface) of the construction article as the fiberized adhesive layer is formed. Following application of the adhesive layer, a release liner can be subsequently applied to cover the layer of fiberized adhesive. In one or more embodiments, further processing of the adhesive layer may occur prior to application of the release liner. For example, where the fiberized web is prepared from UV-curable adhesive, the application of UV-energy may be applied prior to application of the release liner. The composite that is formed can then be, especially in the case of membranes and fabrics, wound, optionally stored, and shipped to a construction site as a wound roll as shown in FIG. 2.

In other embodiments, the composites of the present invention may be manufactured by using transfer coating techniques. For example, the fiberized pressure-sensitive adhesive may be directly applied onto a release liner. This may advantageously take place in conjunction with the manufacture of the construction article, or it may take place as a separate and distinct process, in which case the release liner carrying the fiberized layer of pressure-sensitive adhesive may be wound into a roll and stored and/or transported. Where rolled, the roll can then be unwound within, for example, a continuous process where the non-woven adhesive layer is then mated with a surface of the construction article.

### INDUSTRIAL APPLICABILITY

The composites of the present invention can advantageously be used in a number of building constructions and may advantageously be installed by using “peel-and-stick” installation techniques. For example, the construction composite can be placed at a location near the substrate or structure to which it will be secured, the release paper can be removed, and then the exposed pressure-sensitive adhesive layer can be secured to the structure or substrate through proper placement and the application of pressure. In one or more embodiments, the process of installation is advantageously devoid of mechanical fastening procedures.

Various modifications and alterations that do not depart from the scope and spirit of this invention will become apparent to those skilled in the art. This invention is not to be duly limited to the illustrative embodiments set forth herein.

1. A construction composite comprising:
i. a construction article having a planar surface; and
ii. a non-woven layer of pressure-sensitive adhesive disposed on the planar surface.

2. The construction composite of claim 1, further comprising a release liner disposed on said non-woven layer of pressure-sensitive adhesive opposite said construction article.

3. The construction composite of claim 1, where the composite is in the form of a roll.

4. The construction composite of claim 1, where the non-woven construction material is vapor permeable.

5. The construction composite of claim 1, where the composite is vapor permeable.

6. The construction composite of claim 1, where the construction article is a fabric.

7. The construction composite of claim 1, where the construction article is a membrane

8. The construction composite of claim 1, where the construction article is a construction board.

9. The construction composite of claim 1, where the pressure-sensitive adhesive is selected from the group consisting of acrylic polymers, butyl rubber, ethylene vinyl acetate, natural rubber, nitrile rubber, silicone rubber, styrene block copolymers, ethylene-propylene-diene rubber, ataticpolyalpha olefins, and vinyl ether polymers.

10. The construction composite of claim 1, where the pressure-sensitive adhesive is an asphalt-based composition.

11. The construction composite of claim 1, where the pressure-sensitive adhesive is a UV-cured pressure-sensitive adhesive.

12. A self-adhering non-woven composite comprising:
i. a non-woven construction fabric; and
ii. a non-woven layer of pressure-sensitive adhesive disposed on a surface of said non-woven construction material.

13. The self-adhering non-woven composite of claim 12, further comprising a release liner disposed on said non-woven layer of pressure-sensitive adhesive opposite said non-woven construction fabric.

14. The self-adhering non-woven composite of claim 12, where the pressure-sensitive adhesive is a UV-cured pressure-sensitive adhesive.
